(19) United States
(12) Patent Application Publication
(10) Pub. No.: US 2012/0241181 A1
(43) Pub. Date: Sep. 27, 2012

(54) AGRICULTURAL SOIL CULTIVATION DEVICE

(75) Inventor: Philipp Horsch, Schwandorf (DE)

(73) Assignee: Horsch Maschinen GmbH, Schwandorf (DE)

(21) Appl. No.: 13/415,328

(22) Filed: Mar. 8, 2012

(30) Foreign Application Priority Data
Mar. 23, 2011 (EP) 11159348.9

(51) Int. Cl. A01B 23/06

(52) U.S. Cl. 172/518

(57) ABSTRACT

The present invention relates to a soil cultivation device with a rotating roller implement, comprising a shaft rotating around an essentially horizontal axis, with a multitude of crescent shaped spring elements arranged over the entire circumference and width of said shaft, with the spring elements each being fastened to the shaft at one end section, and being bent in the direction of their other, free end section before extending arcuately along a circumferential segment of an outer circumference or a quasi-circular outline of the roller implement, with said circumference or outline being nearly coaxial to the rotating shaft. At least some of the spring elements comprise, in at least one area with a flat cross-section, a defined elastic pliability, and comprise in at least one section in the direction toward the free end and/or in the area of their circumferential segment a profiled cross-section of a defined bending stiffness.

The present application claims the benefit of European Application No. EP 11159348.9, filed Mar. 23, 2011.

The present invention relates to an agricultural soil cultivation device with the features of the independent claim.

So-called packer rollers are often employed in agricultural tillage for the purpose of seedbed preparation. Such packer rollers are mostly employed as trailing implements, designed in particular to be trailed behind a plow, thereby breaking up the rough clods previously loosened by plowing into finer clods as well as firming up and packing the soil for planting. In this way it is intended to prepare a seedbed suitable for seeding and planting by promoting the ventilation of the soil, conditioning the soil, and improving capillary water movement through the soil. It is, however, also possible and customary for such packer rollers to be employed behind a multitude of other soil cultivation devices, for instance behind sowing machines

The known packer rollers often comprise several relatively narrow metal discs of a diameter of approximately 40 to 100 cm each, whereby said discs are journaled on a cross shaft in such a way that they can be rotated separately from each other. This results in a multitude of variants. It is, for instance, possible for individual rings to be firmly attached to each other. Due to their heavy weight of up to 600 kilograms per meter working width, the discs of the packer rollers penetrate deeply into the soil. There are drag-type packer rollers that are pulled behind a plow or packer rollers that are fixedly attached to the plow in an all-in-one implement.

In addition to the above-mentioned variants, there are various other known designs for agricultural cultivation device combinations that include packer rollers. The roller-type bodies can, for instance, be either open or closed. It is also possible to use different kinds of materials for manufacturing the rotating members, such as rings or bodies made of steel or plastic. In lighter soils and shallow working depths, it is alternatively possible to substitute the metal discs for rubber tires that can be either air-filled or self-supporting.

Furthermore, packer roller designs with either rigid or flexible elements are already known, for instance from EP 0 998 185 B1. In this device, there are several steel spring elements arranged in such a way that they can flexibly adjust to the rolling movement and are pliable until they come to rest against a rigid stop. Under applied load, this results in a nearly closed ring capable of bearing the weight of the machine One advantage among others of such movable spring elements lies therein that they are effectively self-cleaning when working in sticky ground conditions, as the moving elements will simply keep shaking off any soil clinging to them. In principle, any number (from 2 to n) of such movable elements in these packer rollers can be screwed together in circumferential direction to form a ring element. EP 0 998 185 B1 for instance displays multi-part ring elements, each assembled of four individual springs. It is possible to arrange these rings at different distances to each other on a tubular shaft, resulting in a roller body that can have any width.

EP 1 038 423 A1 discloses a further packer roller device, although in this one the nearly closed rings are formed by three spring elements each. Several of such flexible rings form the roller body of the packer roller, with comb components interlocking between each two adjacent rings.

DE 10 2009 032 373 A1 displays a soil cultivation device with an horizontally rotating shaft and crescent shaped spring arms arranged thereon, whereby one end of each spring arm is fastened to the shaft and the free ends of the spring arms form part of the ring around the axis and are resiliently pliable. The crescent shaped spring arms project outward from the shaft in a direction deviating from the radial direction and proceed in a loop to that section that forms part of the ring around the axis.

Another embodiment variant of a packer roller device with flexible spring elements is known from the WO 02/082 880 A2, while U.S. Pat. No. 2,776,532 A describes a packer roller with relatively rigid outer interlocking elements.

The spring elements used in the packer roller devices as known from the prior art are fabricated from a flat, elastic material, such as spring steel. This can, however, result in various problems. If too much force is imposed on the central area of a spring element, i.e. on the area between fastening and stop, by rolling over the ground, over bumps, or stones, in particular in the instance of very heavy machinery, then it is possible for such a flat spring as known, for instance, from EP 0 998 185 B1, to buckle under this high strain, thus causing plastic deformation to the material, which can then lead to a more rapid failure and damage of the spring. In order to avoid this problem, the material thickness or the thickness of the flat spring is then increased to an extent that prevents plastic deformation, resulting, however, in uncalled-for heavy weights and high costs. In addition, the thicker material in the resilient spring area leads the spring to become increasingly stiff and in turn more prone to damage. In order to counter this effect, thicker springs require a longer stop or a reduced spring deflection to protect the spring from overextension. This in turn has a negative impact on the self-cleaning effect.

On the basis of packer roller devices as known from the prior art, the prior objective of the present invention is seen in providing an improved packer roller device that offers the desired elastic features of the spring elements at a relatively light machine weight and without the increased risk of damage to these spring elements. It is additionally intended that the self-cleaning function should remove soil from the spring elements as effectively as possible.

This objective of the invention is achieved by the subject matter of the independent claims. Features of advantageous developments of the invention are indicated in the respective dependent claims. In order to achieve the stated objective, the invention proposes an agricultural soil cultivation device with a rotating roller implement having the features of the independent claim 1, with said device comprising a shaft rotating around an essentially horizontal axis, and with a multitude of crescent shaped spring elements arranged over the entire circumference and width of said shaft, with said spring elements each being fastened to the shaft at one end section. The spring elements are each formed in such a manner that they are bent in the direction of their other, free end section and so that they extend along a circumferential segment of an outer circumference or a quasi-circular outline of the roller implement, with said circumference or outline being nearly coaxial to the rotating shaft. According to the invention, at least some of the spring elements or optionally all of the spring elements have, in at least one flat cross-sectional section, a defined elastic pliability, and in at least one section toward the free end and/or in the area of their circumferential segment they comprise a profiled cross-section of a defined bending stiffness. These cross-sectional profiles of the spring elements can be formed, for instance, by roof-shaped outlines and/or by once or multiply folded or angled outlines.

The subject matter of the present invention thus solves the problems referred to above by applying a profile to the deformation-prone area of each spring element and thereby achieving a particularly high stiffness. The profiled area essentially comprises the rolling circumference of the spring between the area where it is fastened and the stop. There are various ways of designing the profile, preferably however in such a manner that the section modulus is as high as possible on the one hand, and that the profile at the same time enhances the crushing effect while tilling the soil in the field on the other hand. It is possible to use roof-shaped profiles, but also U-shaped cross-sections or any wave-like forms with several ribs.

The benefit thereof is that the spring elements can be fabricated from thinner material, resulting in the following advantages, among others. The profiled area is made to become particularly stable and stiff. According to the profile used, it is possible to reduce the material thickness by up to 50% without reducing the stiffness in comparison to other known designs.

In a further advantageous embodiment variant of the soil cultivation device according to the invention, it is possible for the profiles to extend broadly across the entire length of the area toward the free end that describes the arc of the circumferential segment of the roller implement. It is optionally possible to have the profiles vary in form and/or depth across the length in order to achieve a stiffness that is adjusted to typical deformation behavior and to the loading forces imposed. In this way, the spring elements can have varying profile depths and therefore different elastic properties or varying bending stiffness, for instance along their longitudinal extension in the direction of the free end.

Furthermore, it is possible for the spring elements to be fastened to the shaft projecting outward radially or at an acute angle in relation to the radial direction, and they can be curved in tangential direction in the area of the outer circumference of the roller implement and in the direction of the circumferential segment. It is thus possible to bend the spring elements in a narrow radius at an angle of approximately 80 to 130 degrees and to omit the profiles in this area, making them especially resilient in this arcuate spring portion. In the other sections that are adjacent to the 80° . . . 130° bend, the spring elements are, in contrast, profiled in the manner described above and therefore bend stiff. The radius or angle of curvature will preferably, however, have a narrower range, for instance approximately 100° . . . 110°.

The free ends of the spring elements are preferably each supported by an end stop, with these end stops each being fastened to the shaft, in the form of, for instance, radially projecting beams or the like. As the fixture or fastening of one spring element typically abuts immediately on the end stop of another adjacent spring element, it is possible to structurally integrate them as a single piece. In contrast to spring elements as known from the prior art, these elements are made of thinner material in the resilient area of the spring with the result that deflection to the stop will no longer lead to overextension, making the spring area especially fatigue-resistant. The stop can optionally be shortened, thereby increasing spring deflection and improving self-cleaning properties.

It can also be advantageous to design or to contour at least some of the end stops, preferably, however, all of the end stops, at their front sides pointing toward the respective free ends of the spring elements in a manner corresponding to the profile of the said spring elements. In this way, it is possible for the front sides of the end stops to be profiled correspondingly to the profile of the cross-section of the spring element, so that the spring element can rest form-lockingly against the end stop. This will reliably prevent the spring elements from slipping off the sides of the stops. By aligning the stop to the profile of the spring elements in this manner, the latter will fit centrally on the stops and will remain laterally fixed under strain. Any lateral buckling and/or slipping off of the packer roller spring from the stop is in this way forestalled.

The available spring deflection is defined by the respective distances between the front sides of the end stops from the free ends of the spring elements in a relaxed or unloaded state. The major areas of contact with the soil for the packer roller are these profiled sections. Compared to the hitherto flat spring, profiling the spring elements has the exceedingly positive and desired effect of additionally improving their soil shredding functions. It is possible to achieve a significant reduction in weight and cost of the elements.

One variant of the soil cultivation device according to the invention includes a multitude of groups of spring elements arranged across the working width of the roller implement spaced at the same or different intervals from each other, whereby the individual groups are each made up of either two spring elements with circumferential segments of approximately 180 degrees each, or three spring elements with circumferential segments of approximately 120 degrees each, or four spring elements with circumferential segments of approximately 90 degrees each, or five spring elements with circumferential segments of approximately 72 degrees each, etc. It is reasonable that the number of mechanical end stops provided corresponds to the number of spring elements.

According to a further option of the soil cultivation device, at least some of the spring elements can additionally be profiled, folded, and/or serrated along at least a part of the direction of their longitudinal extension, in this way further improving the desired self-cleaning effect when tilling the soil.

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

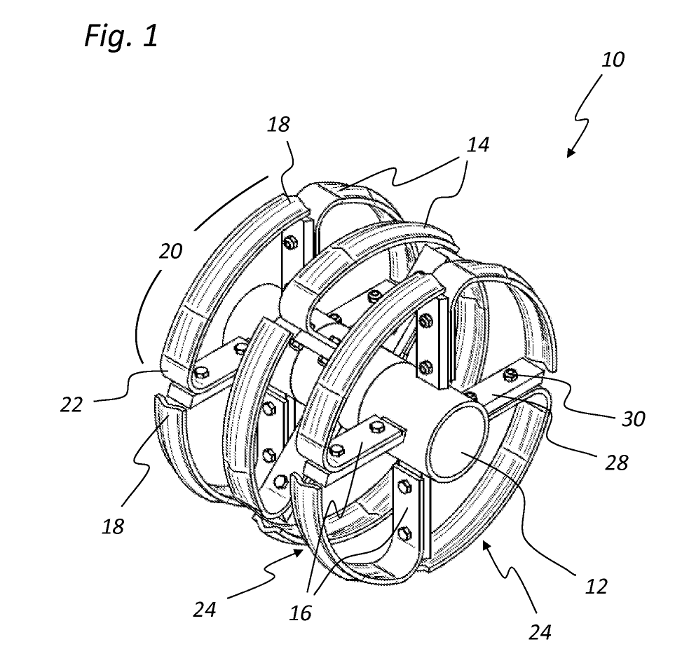

FIG. 1 shows a perspective illustration of a part of an agricultural soil cultivation device according to the invention with a rotating roller implement.

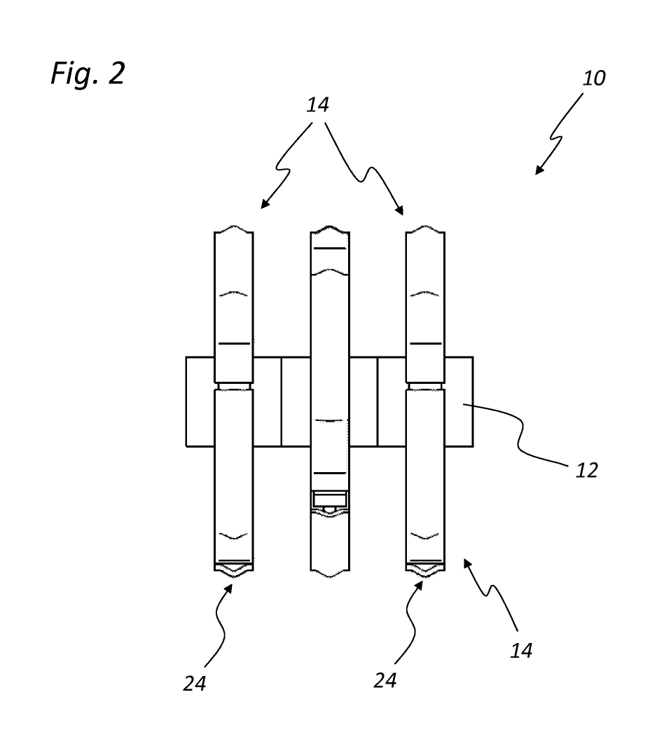

FIG. 2 shows a frontal view of the roller implement displayed in FIG. 1.

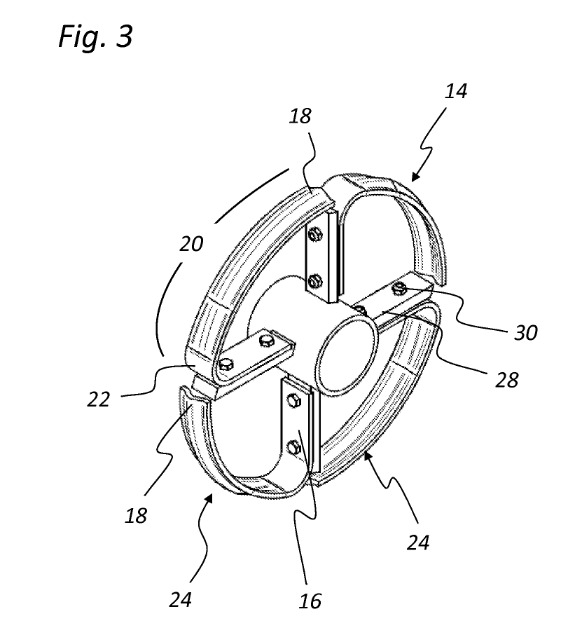

FIG. 3 shows a perspective view of a functional detail of the roller implement according to FIG. 1.

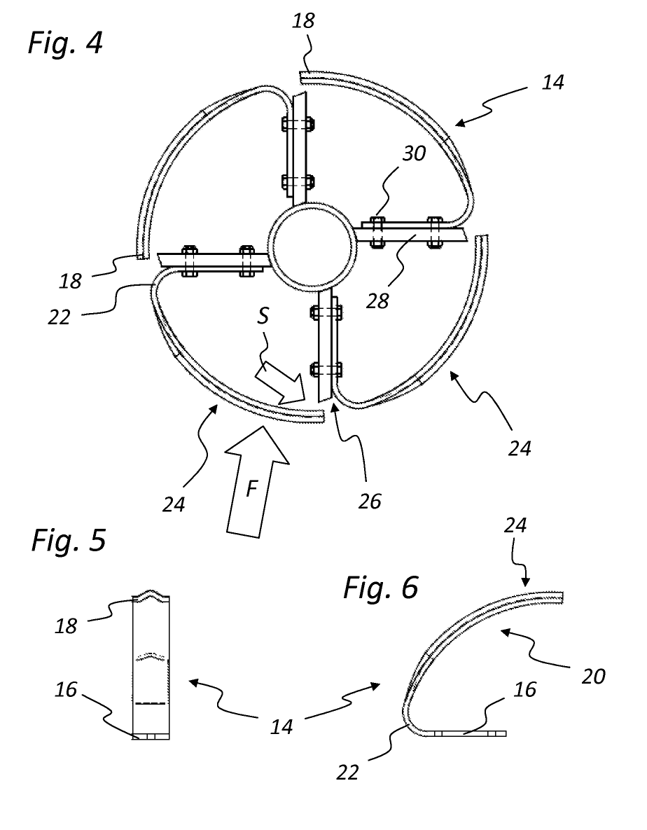

FIG. 4 shows a lateral view of the components of the roller implement as represented in FIG. 3.

FIG. 5 shows a top view of a spring element of the roller implement.

FIG. 6 shows a lateral view of the spring element according to FIG. 5.

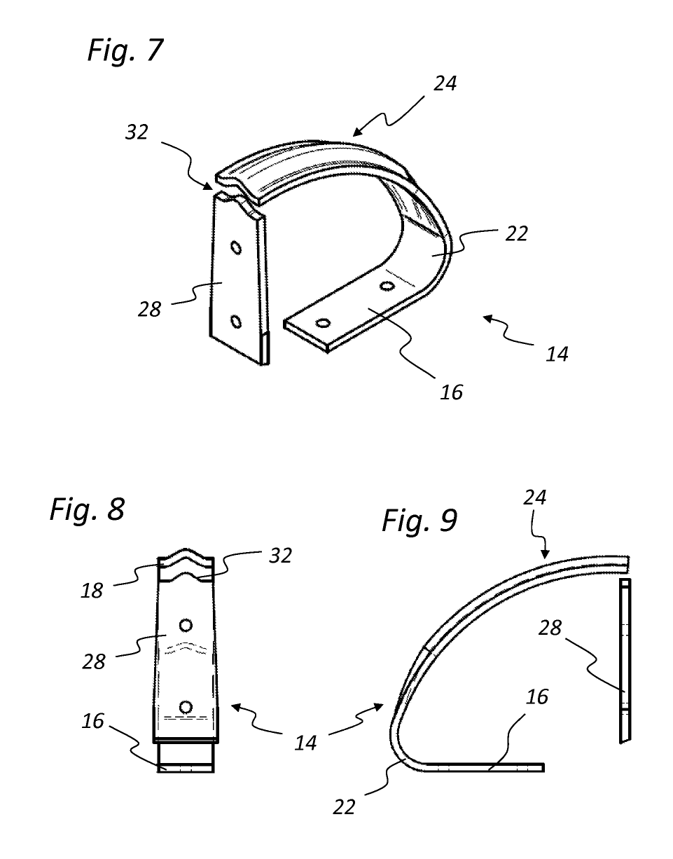

FIG. 7 shows a perspective illustration of the mechanical stop interacting with a spring element of the roller implement.

FIG. 8 shows a schematic top view of the stop and the spring element according to FIG. 7.

FIG. 9 shows a schematic lateral view of the stop and the spring element according to FIG. 7.

The same or equivalent elements of the invention are each designated by the same reference characters in the FIGS. 1 to 9. Furthermore, for the sake of clarity, and to some extent only those reference characters that are relevant for describing the respective figure are provided. It should be understood that the detailed description and specific examples of the device and method according to the invention, while indicating preferred embodiments, are intended for purposes of illustration only and are not intended to limit the scope of the invention.

The schematic perspective drawing in FIG. 1 and the front view in FIG. 2 both illustrate the essential components of an agricultural soil cultivation device according to the invention by giving an exemplary embodiment, whereby however only a short section of a rotating roller implement 10 with three so-called packer modules or units spaced apart from and adjacent to each other is represented. The soil cultivation device, which is typically pulled behind an agricultural towing vehicle, in particular behind a drag-type plow (not illustrated here), serves for breaking up clods of earth that were previously loosened by plowing and for packing the soil to prepare it for subsequent sowing. The perspective view in FIG. 3 and the lateral view in FIG. 4 illustrate the functional detail of the roller implement 10 according to FIG. 1.

For the purpose of soil cultivation subsequently to plowing, the rotating roller implement 10 comprises a shaft 12 rotating around an essentially horizontal axis with a multitude of crescent shaped spring elements 14 arranged over the entire circumference and width of said shaft 12, whereby said spring elements 14 are each fastened to the shaft 12 at one end section 16. The spring elements 14 are each formed in such a manner that they are bent in the direction of their other, free end section 18 and so that they extend along a circumferential segment 20 of an outer circumference or a quasi-circular outline of the roller implement 10, with said circumference or outline being nearly coaxial to the rotating shaft 12.

In order to fulfill the intended purpose in the desired manner, the spring elements 14 have a defined elastic pliability in a strongly bent arcuate spring portion 22 between their end sections 16 that are fastened to the shaft 12 and the area that is curved to form the circumferential segment 20. To this end, the strongly bent, flexible, arcuate spring portion 22 comprises an unprofiled flat cross-section so that the material thickness and material characteristics of the spring elements 14, which are typically fabricated from steel, in particular from spring steel, define the elastic properties and the spring stiffness of the spring portion 22 in this section of the spring elements 14.

According to the present invention, the spring elements 14 comprise a profile or a profiled cross-section 24 with a defined bending stiffness in the area of their circumferential segment 20 and in the direction toward the free end 18. These cross-sectional profiles 24 of the spring elements 14 can be formed in the illustrated manner, for instance, by roof-shaped outlines and/or by once or multiply folded or angled outlines. It is therefore possible to use relatively thin spring steel for fabricating the spring elements 14. Since the profiled area is particularly stable and stiff, it is possible to reduce the material thickness of the spring elements 14 by up to 50% or more, according to the profile 24 used, without reducing the stiffness in comparison to other known designs.

As illustrated in the FIGS. 1, 3, and 4, the profiles 24 of the spring elements 14 can extend broadly across the entire length of the circumferential segment 20 in the direction toward the free end 18. It is optionally possible to have the profiles 24 vary in form and/or depth across the length in order to achieve a stiffness that is adjusted to typical deformation behavior and to the loading forces imposed. In this way, the spring elements 14 can have varying profile depths and therefore different elastic properties or varying bending stiffness, for instance along their longitudinal extension in the direction of the free end 18.

The schematic lateral view in FIG. 4 illustrates the loading forces F imposed by the weight force of the machine, which is not illustrated here, and the spring deflection S that is respectively available for the deformation of the spring elements 14, whereby the available spring deflection S is located between the free end 18 of each spring element 14 and a mechanical stop for the respective spring element 14. As especially FIG. 4 makes clear, the spring elements 14 may project radially outward at their end section 16 that is fastened to the shaft 12 and each be screwed together, for instance by means of two fastening screws 30, with a corresponding, radially extending crosspiece or projection 28. Extending from their radial sections 16 of the spring elements 14 that are screwed together with the crosspiece or projection 28, the spring elements 14 then continue to form the arcuate spring portion 22 at an acute angle of approximately 100 degrees to 110 degrees in relation to the radial direction, as shown in particularly in FIG. 4 and FIG. 6. The direction of the longitudinal axis of the spring elements 14 subsequently extends along the circle outline toward the free end 18, forming the circumferential segment 20 in such a way that the said spring elements 14 are curved in tangential direction in the area of the outer circumference of the roller implement 10 and in the direction of the circumferential segment 20.

The arcuate spring portion 22 can optionally comprise other angles of curvature, ranging, for instance, from approximately 80 degrees to approximately 130 degrees.

As once more illustrated in FIG. 6 by the individual spring element 14, the arcuate spring portion 22 can in particular be bent at an angle of approximately 100 to 110 degrees in a narrow radius and preferably be unprofiled in this section, investing this arcuate spring portion 22 with the desired spring effect. In the other areas of the circumferential sections 20 that are adjacent to the flexible arcuate spring portion 22, the spring elements 14 are, in contrast, profiled in the manner described above and therefore bend stiff.

In FIG. 4 the spring deflection S made available with the spring elements 14 has already been illustrated. This spring deflection S is thus defined by the distance between the free ends 18 of the spring elements 14 in an unloaded state and the mechanical end stops 26 respectively allocated to the said spring elements 14, with the mechanical end stops 26 each being fastened to the shaft 12, forming, for instance, radially extending beams, crosspieces, or projections 28, as shown in the figures. As the fixtures of the spring elements 14 each abut immediately on the end stop 26 of the adjacent spring element 14, the exemplary embodiment illustrated here has these parts structurally integrated as a single piece. In this way, the end stops 26 each serve for mounting the screw connections 30 of an adjacent spring element 14. The special advantage that this arrangement according to the invention has above known spring elements lies therein that by using thinner material in the resilient spring area, deflecting the spring element 14 up to the stop 26 by utilizing the available maximal spring deflection S will no longer result in overextension, thus rendering in particular the spring portion 22 fatigue-resistant. The stop 26 can optionally be shortened, thereby increasing spring deflection S and improving self-cleaning properties.

The FIGS. 7, 8, and 9 show a further advantageous variant of the rotating roller implement 10 according to the invention, in which at least some of the end stops 26, preferably, however, all of the end stops 26, are designed or contoured at their front sides 32 that point toward the respective free ends 18 of the spring elements 14, with the design or contour at their front sides 32 corresponding to the profile 24 of the said spring elements 14. The front sides 32 of the end stops 26 will thereby be profiled correspondingly to the profile 24 of the cross-sections of the spring elements 14 in order to create a form-locking support for each of the free ends 18 of the spring elements 14. This will reliably prevent the spring elements 14 from slipping off the sides of the stops 26. By aligning the stops 26 to the profiles 24 of the spring elements 14 in this manner, the spring elements 14 will fit centrally on the stops 26 and will remain laterally fixed under strain. Any lateral buckling and/or slipping off of the packer roller springs from their respective end stops 26 can be excluded is in this way.

The available spring deflection S is defined by the respective distances between the front sides 32 of the end stops 26 from the free ends 18 of the spring elements 14 in a relaxed or unloaded state. The major areas of contact with the soil for the packer roller are these profiled sections 24. Compared to the hitherto flat spring, the profiling 24 of the spring elements 14 has the exceedingly positive and desired effect of additionally improving their soil shredding functions. It is possible to achieve a significant reduction in weight and cost of the spring elements.

As shown in the figures, it is possible to arrange a multitude of grouped spring elements 14 across the working width of the roller implement 10 and thereby space them at the same or different intervals from each other. Each of these groups is made up of a total of four spring elements 14 distributed across the circumference in such a way that the individual spring elements form circumferential segments of approximately 90 degrees each. Other partitions are, of course, also possible, for instance two spring elements with circumferential segments of approximately 180 degrees each, or three spring elements with circumferential segments of approximately 120 degrees each, or five spring elements with circumferential segments of approximately 72 degrees each, etc. The corresponding number of crosspieces 28 will each serve as mechanical stops 26 for the respective spring elements 14.

According to a further option for the roller implement 10 of the soil cultivation device according to the invention, this option however not being illustrated here, may furthermore provide for at least some of the spring elements 14 to be additionally profiled, folded, and/or serrated along at least a part of the direction of their longitudinal extension, in this way further improving the desired self-cleaning effect when tilling the soil.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

### LIST OF REFERENCE CHARACTERS

10 Rotating roller implement
12 Shaft
14 Spring element
16 End section
18 Free end, end section
20 Circumferential segment
22 Bend, arcuate spring portion
24 Profile, profiled cross-section
26 Stop, end stop, mechanical stop
28 Crosspiece, projection
30 Screw connection
32 Front side
F Force, loading force
S Spring deflection

I claim:

1. An agricultural soil cultivation device with a rotating roller implement (10), comprising a shaft (12) rotating around an essentially horizontal axis, with a multitude of crescent shaped spring elements (14) arranged over the entire circumference and width of said shaft (12), with said spring elements (14) being fastened to the shaft (12) each at one end section (16), and being bent in the direction of their other, free end section (18), then extending arcuately along a circumferential segment (20) of an outer circumference or a quasi-circular outline, with said circumference or outline being nearly coaxial to the rotating shaft (12), whereby at least some of the spring elements (14) have, in at least one flat cross-sectional section, a defined elastic pliability, and in at least one section in the direction toward the free end (18) or in the area of their circumferential segment (20), a profile (24) of a defined bending stiffness.

2. The soil cultivation device according to claim 1, wherein the profile (24) of the spring elements (14) may be selected from a roof-shaped outline, a once or multiply folded outline or an angled outline.

3. The soil cultivation device of claim 1, wherein the profile (24) of the spring elements (14) extend broadly across the entire length of the area in the direction toward the free end (18), and wherein the free end (18) describes a circumferential segment (20).

4. The soil cultivation device of claim 1, wherein the spring elements (14) are fastened to the shaft (12) so that they project outward radially or at an acute angle in relation to the radial direction, and wherein said spring elements (14) are curved in tangential direction in the area of the outer circumference and in the direction of the circumferential segment (20).

5. The soil cultivation device of claim 1, wherein the spring elements (14) have varying profiles along their longitudinal extension in the direction toward the free end (18).

6. The soil cultivation device of claim 1, wherein the free ends (18) of the spring elements (14) are each adjacent end stop (26), whereby the end stops (26) are fastened to the shaft (12).

7. The soil cultivation device according to claim 6, wherein at least one of the end stops (26) is contoured at its front sides (32) pointing toward the respective free end (18) of the spring element (14), with the contour designed correspondingly to the profile (24) of the said spring elements (14).

8. The soil cultivation device of claim 6, wherein the distances between the front sides (32) of the end stops (26) and the free ends (18) of the spring elements (14) in their relaxed state respectively define the available spring deflection (S).

9. The soil cultivation device of claim 1, wherein a multitude of groups of spring elements (14) are arranged along the length of the shaft (12) spaced at the same or at different intervals from each other, whereby the individual groups are each provided to have either two or more spring elements (14) with the combined circumferential segments (20) approximating an entire circle.

10. The soil cultivation device of claim 9 whereby the individual groups are each provided to have two spring elements (14) with circumerential segments (20) of approximately 180 degrees each, or three spring elements (14) with circumferential segments (20) of approximately 120 degrees each, or four spring elements (14) with circumferential segments (20) of approximately 90 degrees each, or five spring elements (14) with circumferential segments (20) of approximately 72 degrees each.

11. The soil cultivation device of claim 1, wherein at least one of the spring elements (14) has a multitude of profiles along at least a part of the direction of their longitudinal extension.
